(19) United States
(12) Patent Application Publication
(10) Pub. No.: US 2008/0282555 A1
(43) Pub. Date: Nov. 20, 2008

(54) HEDGE TRIMMER

(75) Inventor: You Yu LIN, Haian Jiangsu (CN)

Correspondence Address: BROWDY AND NEIMARK, P.L.L.C.;624 NINTH STREET, NW, SUITE 300, WASHINGTON, DC, 20001-5303, US

(73) Assignee: Jiangsu Golden Harbour Enterprise Ltd., Haian (CN)

(21) Appl. No.: 11/749,393

(22) Filed: May 16, 2007

(51) Int. Cl. A01G 3/053

(52) U.S. Cl. 30/277.4

(57) ABSTRACT

A hedge trimmer includes a motor, a transmission mechanism, a main handle, a front handle, a switch and a cutter mechanism. The motor drives the cutter mechanism through the transmission mechanism. The main handle is provided at a rear of the hedge trimmer and the front handle is provided at a front of the hedge trimmer, and the front handle may be turned for a predetermined angle. The main handle and the front handle are provided with a main switch and an auxiliary switch at inner sides thereof respectively. The auxiliary switch is connected to a microswitch through a soft shaft or controls a switch, which is serially connected to the main switch, direction.

### BACKGROUND OF THE INVENTION

1. Field of the Invention

The present invention relates generally to a gardening machine, and more particularly to a hand-held hedge trimmer.

2. Description of the Related Art

Hedge trimmer is a specialized machine for gardening to cut hedges and shrubs with an easier operation and high efficiency. The conventional hedge trimmer includes a motor, a transmission mechanism, a main handle, a front handle, a switch and a cutter mechanism to cut hedges in a very convenient way that reduces the loading and time of cutting work much. However, user has to hold the main handle and the front handle to hold the hedge trimmer and turn aside to cut a lateral side of the hedge that increases the loading of the work. With the limitation of the dimension of the hedge trimmer, the handle must be short that is inconvenient to user to cut the higher hedge. The hedge trimmer with longer handle is disadvantageous to package and inconvenience in operation. When user wants to cut the hedge into a predetermined shape, the conventional hedge trimmer has a limited operation range because of the complex factors at outdoors.

### SUMMARY OF THE INVENTION

The primary objective of the present invention is to provide a hedge trimmer, which has telescoping and rotary handles to fit the various situations when user operates the hedge trimmer and provides user with a more convenient and comfortable operational mode in different environments.

According to the objective of the present invention, a hedge trimmer includes a motor, a transmission mechanism, a main handle, a front handle, a switch and a cutter mechanism. The motor drives the cutter mechanism through the transmission mechanism. The main handle is provided at a rear of the hedge trimmer and the front handle is provided at a front of the hedge trimmer, and the front handle may be turned for a predetermined angle. The main handle and the front handle are provided with a main switch and an auxiliary switch at inner sides thereof respectively. The auxiliary switch is connected to a microswitch through a soft shaft or controls a switch, which is serially connected to the main switch directly.

The main handle is connected to a main of the hedge trimmer by passing through a telescoping shaft, and a rotary mechanism is provided between the main handle and the telescoping shaft or between the telescoping shaft and the main.

A telescoping shaft, which includes an inner tube and an outer tube fitted to each other, has opposite ends fixed to a case of the hedge trimmer and the main handle respectively. The inner tube has a slot along an axial direction thereof to be engaged with a protrusion of a lock ring, which is fixed on the outer tube at an overlapped portion of the inner tube and the outer tube so that the inner tube is reciprocated relative to the outer tube without rotation. The inner tube is provided with a plurality of parallel indentations to be engaged with a button for secure the telescoping shaft at different predetermined lengths. The telescoping shaft may be retracted to integrate the main handle hand the main as a unit to have a tight structure.

The rotary mechanism includes a fixed annular slot, a sliding annular slot, a button and a spring. The fixed annular slot and the sliding annular slot, which are provided on two elements respectively that may be rotated relative to each other, have a teeth slot on an inner side and an outer side respectively. The spring urges the sliding annular slot to have the teeth slot of the sliding annular slot engaged with the teeth slot of the fixed annular slot.

The hedge trimmer of the present invention further comprising a pair of lateral handles on opposite sides thereof, each of which has an end connected to a pivotal portion of the front handle through a telescoping shaft respectively and the other end connected to each other through a telescoping shaft to form an annular handle. The lateral handles may be turned downwards, and a rotational center thereof is as same as that of the front handle. A knob is provided to control the rotations of the lateral handles. Each of the lateral handles is provided with an auxiliary switch, which is as same as the auxiliary switch of the front handle and has the same operation mode. When the main switch of the main handle and any one of the auxiliary switches on the front handle and the lateral are pressed in the same time, the hedge trimmer will be started. User may have one hand holding the main handle and the other hand holding the front handle or one of the lateral handles to operate the hedge trimmer.

### BRIEF DESCRIPTION OF THE DRAWINGS

FIG. 1 is a sectional view of a preferred embodiment of the present invention;

FIG. 2 is a top view of the preferred embodiment of the present invention;

FIG. 3 is an exploded view of the telescoping shaft of the preferred embodiment of the present invention;

FIG. 4 is an exploded view of the rotary mechanism of the preferred embodiment of the present invention;

FIG. 5 is a front view of the preferred embodiment of the present invention, showing the main handle being drawn backwards;

FIG. 6 is a top view of the preferred embodiment of the present invention, showing the main handle being drawn backwards and turned aside and the lateral handle opened;

FIG. 7 is a front view of the preferred embodiment of the present invention, showing main handle being drawn backwards and turned to the bottom side and the lateral handle turned downwards; and

FIG. 8 is a front view of the preferred embodiment of the present invention, showing main handle being retracted and turned to the smallest condition.

### DETAILED DESCRIPTION OF THE INVENTION

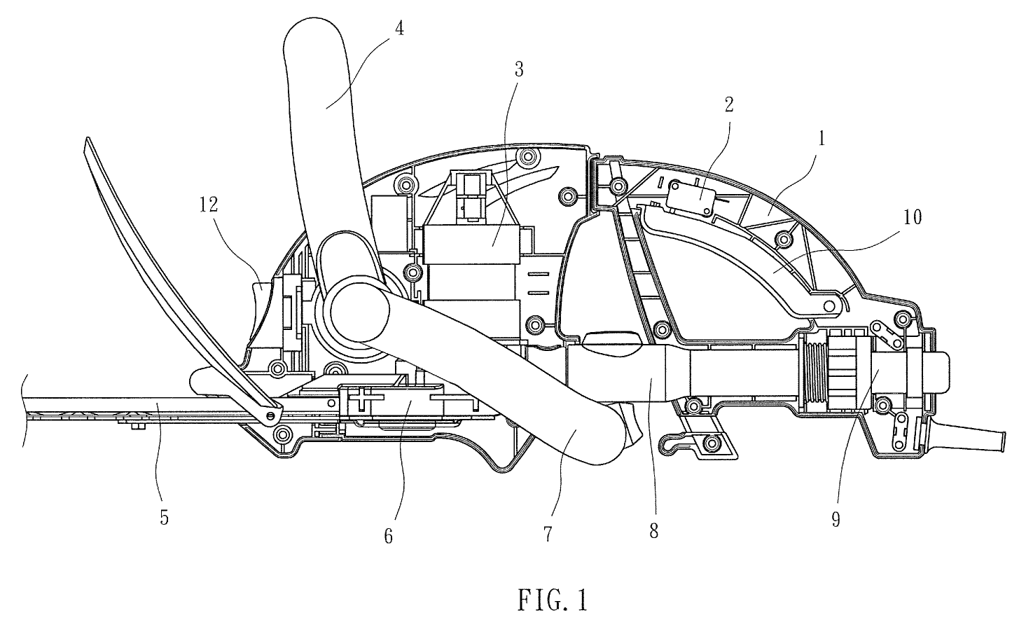

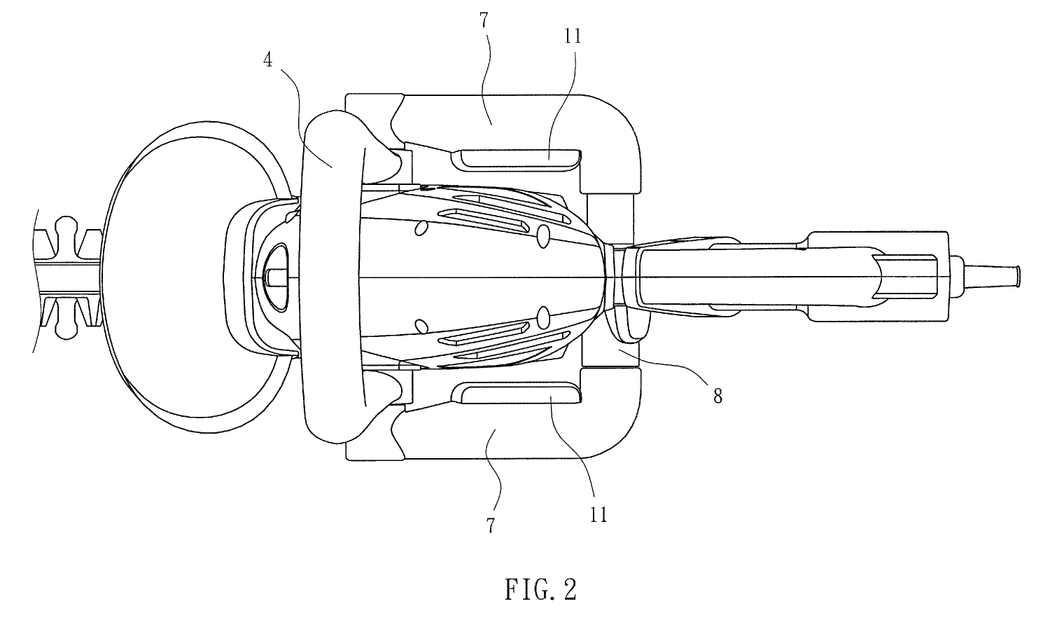

As shown in FIG. 1 and FIG. 2, a hedge trimmer 10 of the preferred embodiment of the present invention includes a motor 3, a transmission mechanism 6, a main handle 1, a front handle 4, a switch 2, a cutter mechanism 5, two lateral handles 7, a telescoping shaft 8 and a rotary mechanism 9. The main handle 1 is fixed to an end of the telescoping shaft 8 through the rotary mechanism 9. The telescoping shaft 8 is connected to a main of the hedge trimmer. The lateral handles 7 are connected to opposite sides of the main respectively to be drawn outwards and a telescoping shaft 8 or the equivalent device thereof at the other ends to connect them. The lateral handles 7 are provided with a telescoping shaft and a rotary mechanism 9 or the equivalent device thereof at the other ends to connect a pivotal portion of the front handle 4. The front handle 4 has a rotary mechanism, which may be as same as aforesaid rotary mechanism. A knob 12 is provided to control the rotations of the front handle 4 and the lateral handles 7 respectively. The main handle 1 has a main switch 10 at an inner side thereof. The front handle has an auxiliary switch (not shown) in an inner side thereof. The auxiliary switch is connected to a microswitch through a soft shaft or connected to a switch, which is serially connected to the main switch 10 directly. The hedge trimmer is started only when both of the main switch 10 and the auxiliary switch are pressed at the same time. The lateral handles 7 are also provided with an auxiliary switch 11 at an inner side thereof respectively. The auxiliary switches 11 have the same operational mode as the front handle 4. It can start the hedge trimmer when both of the main switch 10 and any one of the auxiliary switches 11 are pressed.

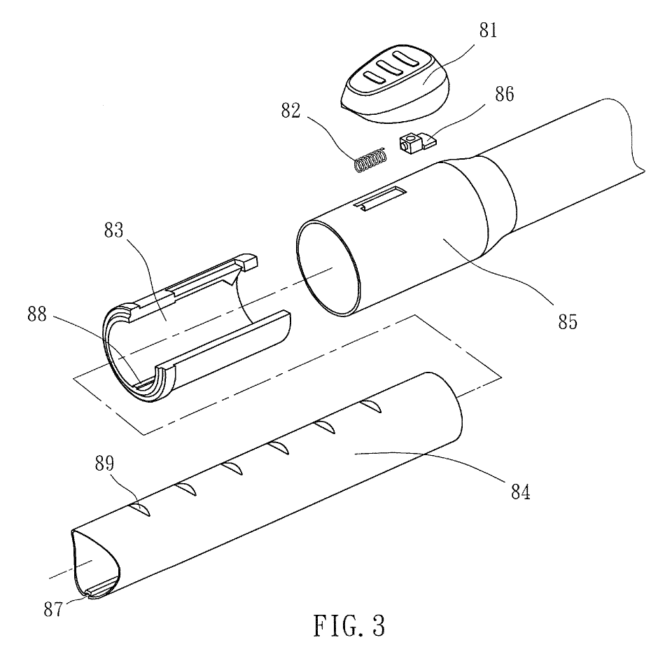

As shown in FIG. 3, the telescoping shaft 8 includes a button 81, a sliding block 86, a spring 82, a lock ring 83, an inner tube 84, and an outer tube 85. The inner tube 84 is inserted into the outer tube 85. The inner and outer tubes 84, 85 are hollow tubes with a spiral guiding line through the inner portion. The lock ring 83 is fixed to the outer tube 85 at an overlapped portion of the tubes. The inner tube 84 has a slot 87 to be engaged with a protrusion 88 of the lock ring 83 for securing the lock ring 83 on the outer tube 85 at the overlapped portion of the tubes and causes the inner tube 84 moved relative to the outer tube 85 without rotation. The inner tube 84 has a plurality of parallel indentations 89. The button 81 is fixed on the sliding block 86, and the spring 82 urges the sliding block 86 that the sliding block 86 locates the lock ring 83 in any one of indentations 89 of the inner tube 84 to secure the telescoping shaft 8. The spring 82 is compressed, and the sliding block 86 releases the lock ring 83 when the button 81 is pressed to extend or short the telescoping shaft 8.

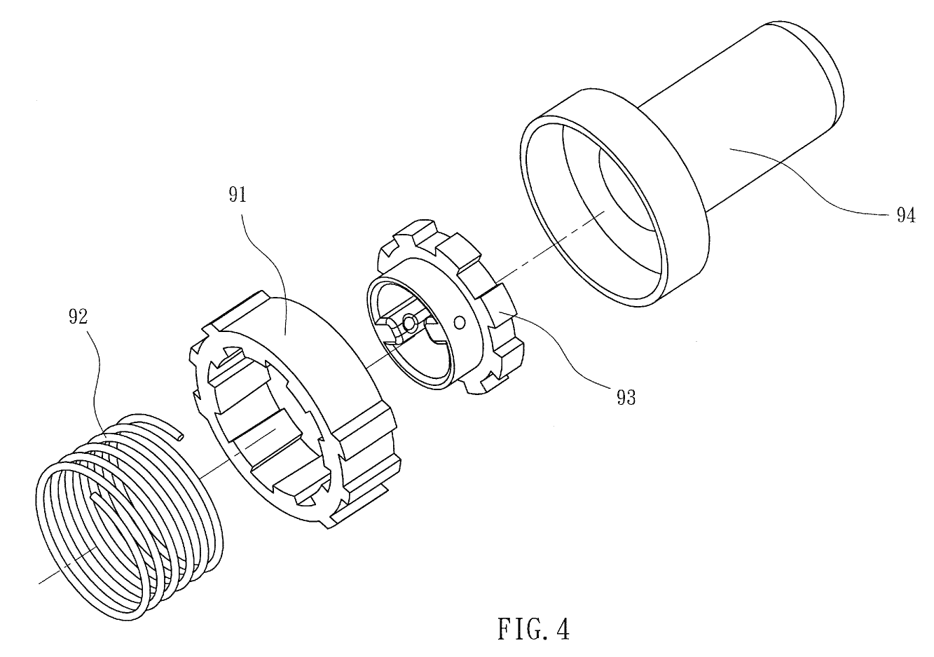

As shown in FIG. 4, the rotary mechanism 9 includes a sliding annular slot 91, a fixed annular slot 93, a spring 92, and a button 94. The sliding annular slot 91 and the fixed annular slot 93 are provided on two elements, which may rotate relative to each other. The sliding annular slot 91 and the fixed annular slot 93 are provided with teeth slots on an inner side and an outer side respectively. The spring 92 urges the sliding annular slot 91 to have the teeth slots of the sliding annular slot 91 and the fixed annular slot 93 meshed with each other that makes sure of no rotation of the sliding annular slot 91 and the fixed annular slot 93. The button 94 is hollow to pass a handle shaft for connection with the fixed annular slot 93. The button 94 pushes the sliding annular slot 91, and the spring 92 is compressed, and the sliding annular slot 91 is separated from the fixed annular slot 93 (the teeth slots thereof are separated) to have the sliding annular slot 91 rotating relative to the fixed annular slot 93 when the button 94 is pressed. The sliding annular slot 91 is moved by the spring 92 toward the fixed annular slot 93 to have the teeth slots thereof meshed that the sliding annular slot 91 is fixed to the fixed annular slot 93 again at a predetermined angle when the button 94 is not pressed. The rotary mechanism 9 may be incorporated in the main handle, the front handle and the lateral handles of the present invention to control their rotations. The knob 12 has an eccentric cam to move the sliding annular slots 91 of two rotary mechanisms 9 by turning the knob 12.

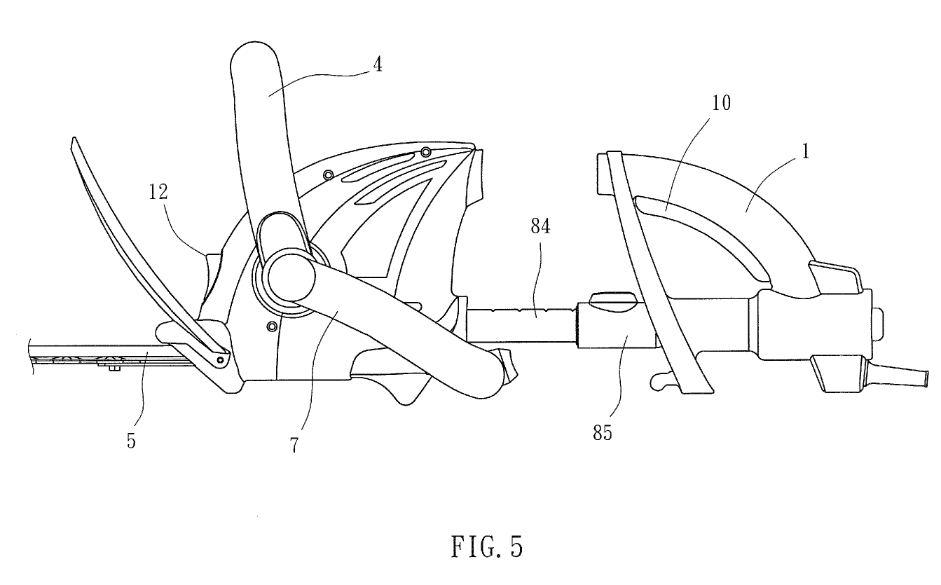

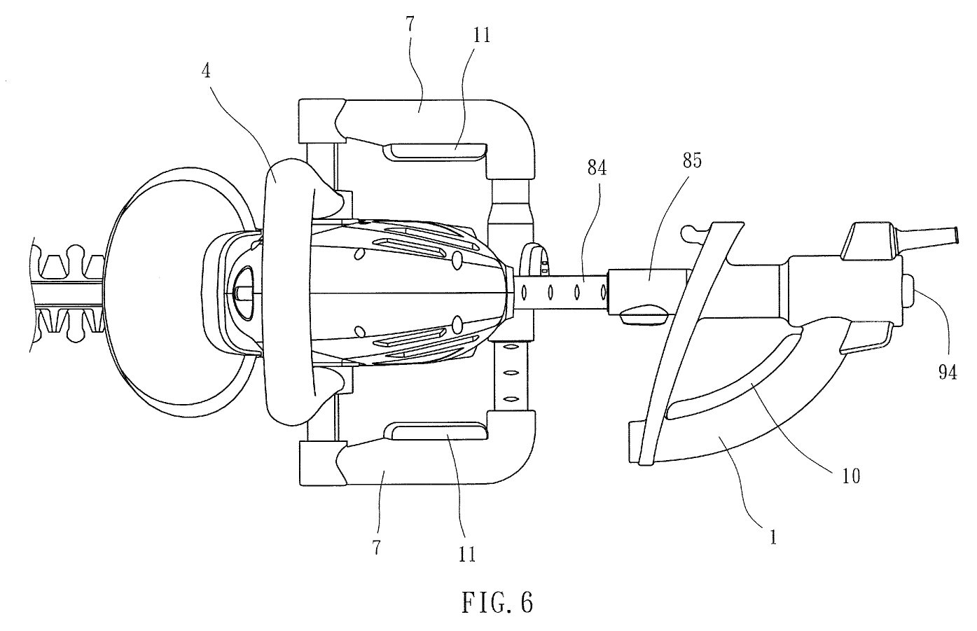

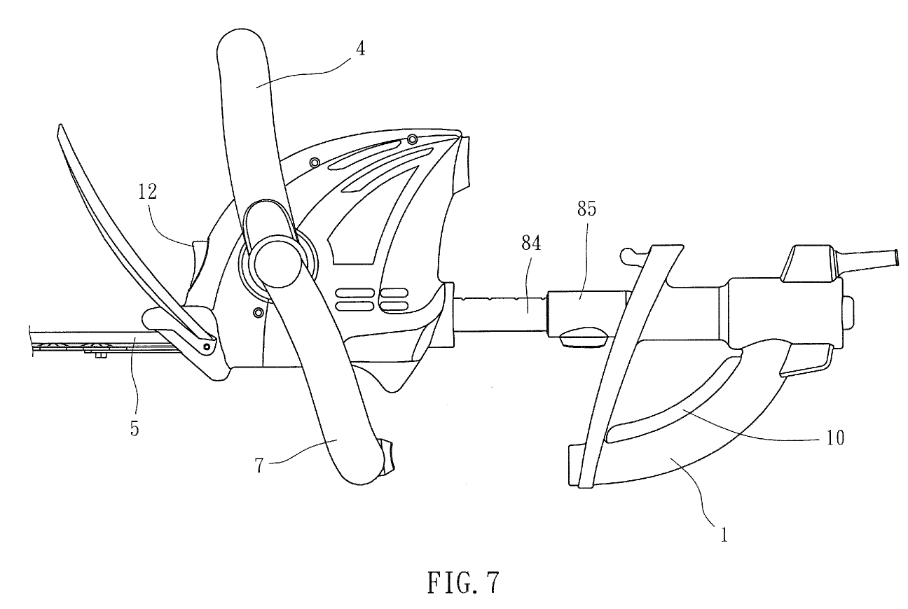

FIGS. 5 to 7 show the telescoping and rotations of the main handle and the lateral handles for different working environments. FIG. 5 shows the main handle of the hedge trimmer is drawn backwards. The distance of drawing the main handle is adjustable by the user according to the work requirement to have different working range for cutting higher and farer hedge. FIG. 6 shows the main handle is drawn backwards and turned ninety degrees and the lateral handles are opened that the hedge trimmer of the present invention may cut the aside hedges. FIG. 6 shows the main handle is drawn backwards and turned 180 degrees and the lateral handles are tuned ninety degrees that the hedge trimmer of the present invention may cut the higher hedges. In combination of the front handle, the user may adjust the hedge trimmer of the present invention to different conditions according to requirements.

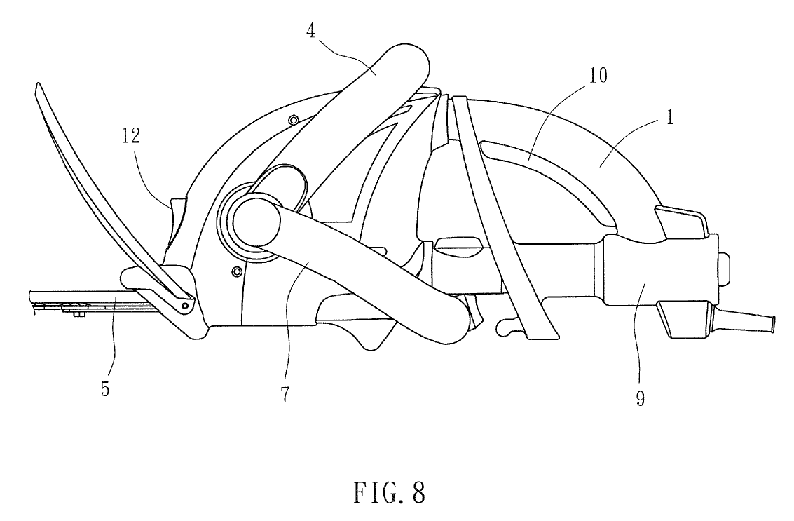

FIG. 8 shows all of the handles of the hedge trimmer of the present invention are retracted and turned to a minimum size for package, storage and transportation.

The advantages of the present invention are that hedge trimmer of the present invention has a plurality of the handles for telescoping and rotation. User may adjust the hedge trimmer of the present invention different condition according to different working requirements and the favor mode of the user holding the hedge trimmer that provides an easier, more relax and higher efficient way of operation. The hedge trimmer of the present invention may be retracted to take less space and save package.

The description above is a few preferred embodiments of the present invention and the equivalence of the present invention is still in the scope of the claim of the present invention.

What is claimed is:

1. A hedge trimmer, comprising:
a motor, a transmission mechanism, a main handle, a front handle, a switch and a cutter mechanism, wherein the motor drives the cutter mechanism through the transmission mechanism, the main handle being provided at a rear of the hedge trimmer and the front handle being provided at a front of the hedge trimmer, and the front handle may be turned for a predetermined angle, and the main handle and the front handle being provided with a main switch and an auxiliary switch at inner sides thereof respectively, and the auxiliary switch being connected to a microswitch through a soft shaft or controls a switch, which is serially connected to the main switch, direction;
the main handle being connected to a main of the hedge trimmer through a telescoping shaft, and a rotary mechanism provided between the main handle and the telescoping shaft or between the telescoping shaft and the main;

2. The hedge trimmer as defined in claim 1, wherein the telescoping shaft, which includes an inner tube and an outer tube fitted to each other, has opposite ends fixed to a case of the hedge trimmer and the main handle respectively, and the inner tube has a slot along an axial direction thereof to be engaged with a protrusion of a lock ring, which is fixed on the outer tube at an overlapped portion of the inner tube and the outer tube so that the inner tube is reciprocated relative to the outer tube without rotation, and the inner tube is provided with a plurality of parallel indentations to be engaged with a button for secure the telescoping shaft at different predetermined lengths.

3. The hedge trimmer as defined in claim 1, wherein the rotary mechanism includes a fixed annular slot, a sliding annular slot, a button and a spring, in which the fixed annular slot and the sliding annular slot, which are provided on two elements respectively that may be rotated relative to each other, have a teeth slot on an inner side and an outer side respectively, and the spring urges the sliding annular slot to have the teeth slot of the sliding annular slot engaged with the teeth slot of the fixed annular slot.

4. The hedge trimmer as defined in claim 1, further comprising a pair of lateral handles on opposite sides thereof each of which has an end connected to a pivot portion of the front handle through a telescoping shaft respectively and the other end connected to each other through a telescoping shaft to form an annular handle.

5. The hedge trimmer as defined in claim 4, wherein the lateral handles may be turned downwards, and a rotation center thereof is as same as that of the front handle.

6. The hedge trimmer as defined in claim 4, wherein each of the lateral handles is provided with an auxiliary switch.

7. The hedge trimmer as defined in claim 5, wherein the each of the lateral handles is provided with an auxiliary switch.
